(19) United States
(12) Patent Application Publication
(10) Pub. No.: US 2022/0158571 A1
(43) Pub. Date: May 19, 2022

(54) Electrostatic power circuit within a power system

(71) Applicant: Nathanial Henry Lewis, Fallon, NV (US)

(72) Inventor: Nathanial Henry Lewis, Fallon, NV (US)

(21) Appl. No.: 16/974,209

(22) Filed: Nov. 17, 2020

(51) Int. Cl. H02N 1/12; H02K 7/10; H02K 11/04

(52) U.S. Cl. CPC H02N 1/12; H02K 11/046; H02K 7/1004

(57) ABSTRACT

This electrostatic power circuit purpose is to build-up a large amount of powerful electrostatic energy. It has a high direct-current voltage generator acting as an electrostatic energy provider in the form of electric charges, next is an electrostatic generator and its electric motor acting as an electrostatic energy amplifier, and last is an electrostatic motor acting as an electrostatic energy convertor, converting electrostatic energy to mechanical energy. The electrostatic power circuit is a major part of a practical electrostatic power system.

### BACKGROUND OF THE INVENTION

The force exerted between two types of charges is repulsive if the charged conductors have the same type of charges (+ or −), and attractive if the charged conductors have opposite type of charges (+ and −). All mediums other than a vacuum act to reduce the force, however the difference between air and a vacuum in the above relationship is negligible. Where the radius of curvature of a conductor is very small, very high electric field intensity is possible in a small region, such as on sharp metal wires and pointed metallic prongs.

Robert J. Van de Graaff in 1935 patented the electrostatic generator that bears his name. The Van de Graaff generator is an impressive electrostatic generator that is capable of producing enormously large static electric potentials (volts). A well-constructed generator that has height of 17 inches and a diameter of 7 inches (dome) can generate a voltage up to 200,000 volts, a modest “class room” size. One that is 3 feet in diameter (dome) and 5 feet in height can generate a voltage of 1,000,000 volts. A giant one can produce millions of volts leading to awesome displays of corona and lightning. This type of generator is definitely superior past 500,000 volts. It can produce these voltages quickly. Electrostatic generators of all types are no toy and even small devices can be dangerous if handled carelessly.

The electrostatic generator has its greatest appeal in the range in excess of 100,000 volts, and power up to 20,000 watts. And the power supply is safe, well stabilized and easily controlled. The output of the direct current (DC) is smooth.

The electromagnetic (EM) assemblies needed for EM generated energy, require expensive and bulky inductors and capacitors when direct current (DC) output must be smooth. Direct currents at very, very high voltages, are transported more efficiently than alternating currents (AC).

There have been several different types of electrostatic generators in the past. There was the Wimshurst electrostatic generator a rotor type—second best—which had its advantages and disadvantages; it isn't use professional any more.

There are several different types of electrostatic motors presently. There is the electrostatic corona motor—second best—they are both low power and efficient machines. The best with excellent power and efficiency is the ELECTROSTATIC REPULSION MOTOR.

### SUMMARY OF THE INVENTION

There is an abundance of alternative energy—the best—in solar energy, wind power and geothermal energy, but each is widely dispersed, they are also relatively weak in some areas and at certain times. Two alternative energies are solar energy and wind power or geothermal energy and wind power or solar energy and geothermal energy. They can be used to built up a large amount of electrostatic energy with a VAN de GRAAFF ELECTROSTATIC GENERATOR. A good energy storage method is needed also for back-up.

At the output of this power circuit is an electrostatic motor. An ELECTROSTATIC REPULSION MOTOR will go far beyond other types of electrostatic motors in performance. Electrostatic energy in a concentrated amount is the second most powerful type of energy, nuclear energy being the first; lightning being an example of electrostatic energy.

This power circuit will be useful, economical, non-polluting and safe. No energy is created, just an exchange of energies, ALTERNATIVE ENERGIES to MECHANICAL ENERGY to ELECTROSTATIC ENERGY back to MECHANICAL ENERGY plus very little losses in HEAT ENERGY.

It would have many applications in the military, industry, commercial and the home; in areas such as electric power plants and propulsion for vehicles; and in and under the sea, on land, in the air and in outer space.

### DRAWINGS FOR THE INVENTION

FIG. 1 is a block diagram of an entire power system with its major sections, one being an electrostatic power circuit.

FIG. 2 is a schematic of the ELECTROSTATIC POWER CIRCUIT.

FIG. 3 is a schematic of a high-voltage generator shown in FIG. 2.

FIG. 4 is a side view of an assembly of an electrostatic repulsion motor.

FIG. 5 is a front view of the motor with an attached speed reducer.

FIG. 6 is a partial side view of the rotor of the motor shown with a partial sectional side view of the stator.

FIG. 7 is a partial sectional view showing a pointed metallic prong in the rotor, a typical line for charging or discharging and each line has an electrical insulation cover cap near the side of the rotor.

FIG. 8 is a top view of a typical cover cap with a charging line or a discharging one.

FIG. 9 is a view of a typical hole in the side of the rotor and comprising sharp metal wires.

FIG. 10 is a schematic of an alternative ELECTROSTATIC POWER CIRCUIT.

### DETAIL DESCRIPTIONS

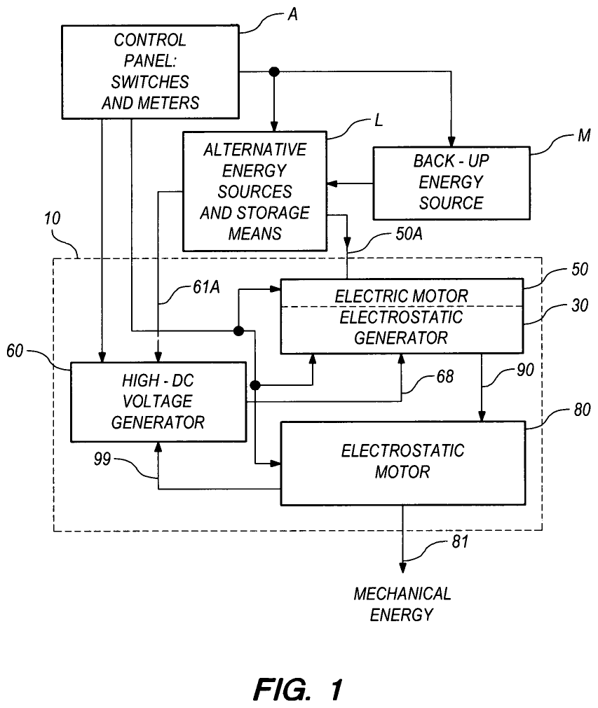

Refer to FIG. 1. A practical ELECTROSTATIC POWER SYSTEM would be comprised of four major sections; they are CONTROL PANEL A, ALTERNATIVE ENERGY SOURCES AND STORAGE MEANS L, BACK-UP ENERGY SOURCE M and the ELECTROSTATIC POWER CIRCUIT 10. The system should be well grounded for safety. The control panel A has switches and meter lines connected to lines throughout the entire system.

The alternative energy sources and storage means L being solar energy, wind power or geothermal and batteries in most cases. Solar energy and wind power are widely dispersed and relatively weak at times, but can be very abundant at other times.

These dispersed and relatively weak energies—solar energy and wind power—can be used to power the electric motor 61 of the high DC voltage generator 60. This generator 60 sends many small amounts of relatively weak electric charges (electrostatic energies) to the electrostatic generator 30 for a build-up of the small electric charges to a powerful voltage quickly. The dispersed and relatively weak energies of the alternative energy sources L, also power the electric motor 50 that power the electrostatic generator 30.

In many applications a BACK-UP ENERGY SOURCE M may be needed for good reliability of the power system. The back-up energy source M can be a fossil fuel engine—electric generator combination. This back-up energy source M would be used only in an emergency; therefore, not causing any environmental or economical problems. A radioisotope thermoelectric generator is another choice.

The electrostatic power circuit 10 has a high DC voltage generator 60, electric motor 50, electrostatic generator 30, and an electrostatic motor 80 as major units. They have several electrical connecting lines 61A, 68, 5A, 90 and 99. Electrostatic energy is a property of nature and not made by humans.

The high DC voltage generator 60 is the circuit 10 reliable ELECTROSTATIC ENERGY PROVIDER by way of the electric charges it generates. The electrostatic generator 30 and its electric motor 50 can be called the powerful ELECTROSTATIC ENERGY AMPLIFIER. The electrostatic motor 80 is the efficient ELECTROSTATIC ENERGY CONVERTER of the circuit 10, converting electrostatic energy to mechanical energy.

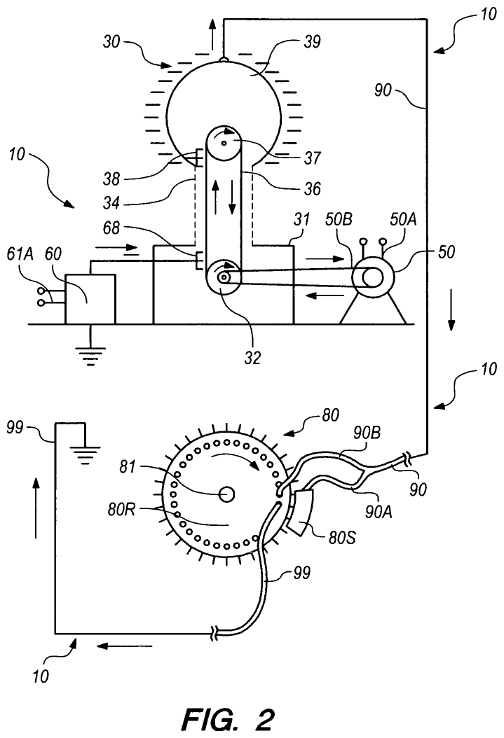

Refer to FIG. 2. The ELECTROSTATIC POWER CIRCUIT 10 has an electrostatic generator 30 of the belt type, a Van de Graff generator. The belt 36 of an electrical insulating material is charged by a set of sharp metal wires 68 connected to the high DC voltage generator 60; it is powered through its electrical terminals 61A. The electric motor 50 is powered through its electrical terminals 50A and its belt 50B power the drive pulley 32. A high-voltage terminal 39 is adjacent to a free rolling pulley 37 and an upper set of sharp metal wires 38 connected to the inside of the high-voltage terminal 39. An insulating support column 34 is between the terminal 39 and a base 31; if the base 31 is metal it should be grounded.

The Van de Graaff electrostatic generator 30 can generate electric charges continuously. The machine has a high degree of precision in the constancy of the developed voltage. The charges—positive or negative—are sprayed on the belt 36 from the set of low sharp metal wires 68 and then be removed from the other end of the belt 36 by the upper set of sharp metal wires 38, and conducted to the outer surface of the high-voltage terminal 39. The terminal 39 is a hollow, metallic spherical dome.

Two other features of a typical Van de Graaff electrostatic generator 30 is its belt size and its speeds. By running wide belts at high speeds, often as high as 60 mph linear velocity, enormous charges can be accumulated and maintain on the dome 39.

The potential reached can be controlled by (a) adjusting the rate of charging the belt 36 by the high DC voltage generator 60; and (b) by controlling the speed of the belt 36 in relation to breakdown voltage and belt leakage; this can be done by controlling the electric motor 50 speed. The motor 50 can be an electromagnetic type or an electrostatic type.

To improve the operation of the Van de Graaff generator 30 and to reduce its size for a given maximum voltage (v), the entire generator is placed inside a steel container in which the air is maintained at a high pressure. This is good for advance rugged applications.

The electrical line 90 goes to the electrostatic repulsion motor 80. The motor 80 has a disked shaped rotor 80R and its axle 81 adjacent a curved stator 80S. The main charging line 90 is connected in parallel to a stator charging line 90A and a rotor charging line 90B. There is a rotor discharging line 99.

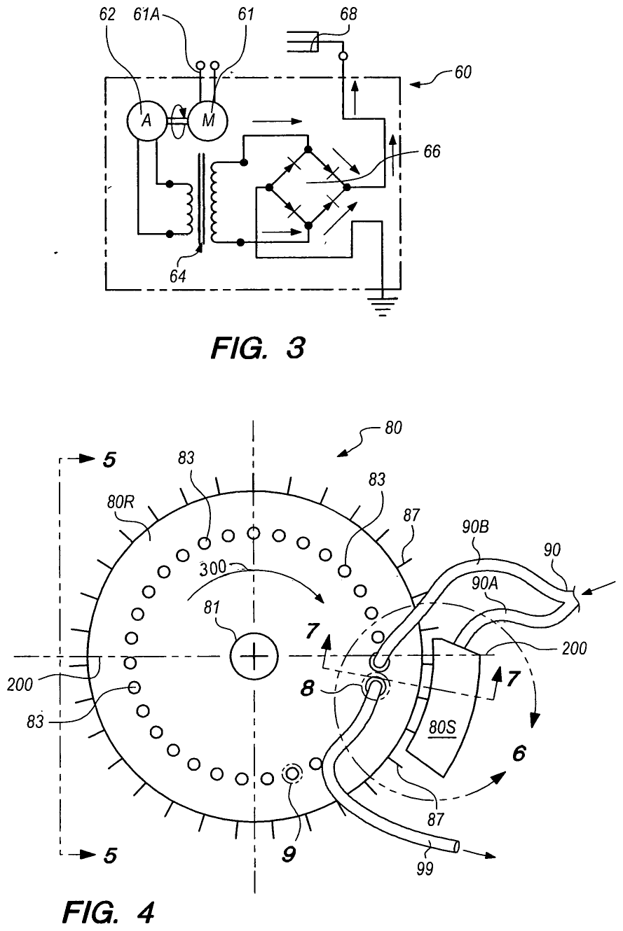

Refer to FIG. 3. This is a circuit for the high DC voltage generator 60. The inner parts are an electric motor 61 with input terminals 61A and can rotate the shaft of an alternator 62. There is a step-up transformer 64 and a full-wave rectifier 66. Charged sharp metal wires 68 spray charges unto the moving belt 36 made of an electrical insulating material. The rectifier 66 is grounded at one terminal.

Refer to FIG. 4. The motor 80 comprises the curved stator 80S and the disk shaped rotor 80R and its axle 81, both have the same width. The curvature of the rim of the rotor 80R matches the curvature of the inner surface of the stator 80S. The rotor 80R and stator 80S should be made from a material that is strong, tough and has good electrical insulation properties. The axle 81 is metallic, The main charging line 90 is connected in parallel to the stator charging line 90A and the rotor charging line 90B. The rotor discharging line 99 is shown. The rotor 80R and the stator 80S are placed on the line 200. The centered and equally spaced pointed metallic prongs 87 in the rim, and equally spaced side holes 83 near the rim are shown on the rotor 80R. Each prong 87 has a side hole 83. The rotor rotation 300 is caused by powerful repulsion forces between two electrostatic charges of the same type, between each pointed metallic prong 87 in the rotor 80R and one pointed metallic prong in the stator 80S.

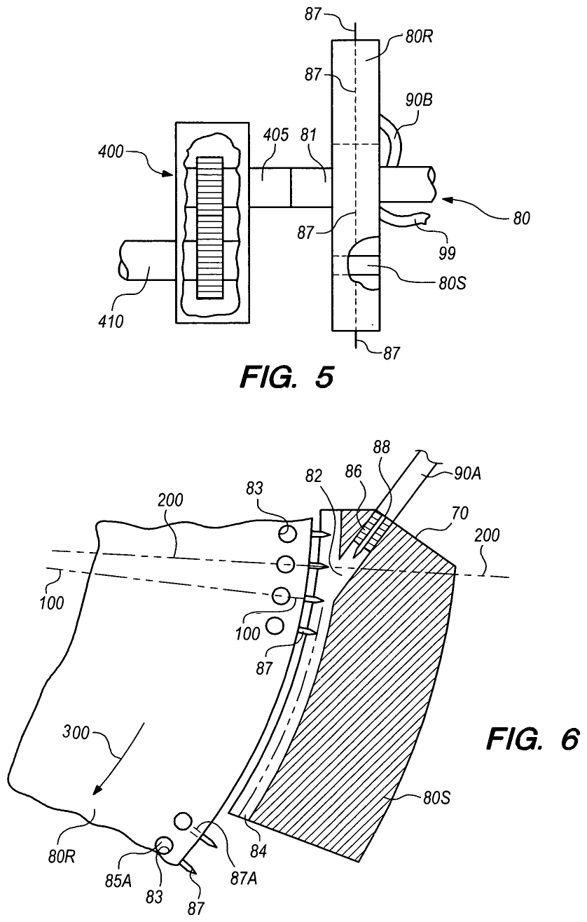

Refer to FIG. 5. All electrostatic motors operate at very high rotary speed as high as 10,000 rpm. For some applications their speeds may be too high and a speed reducer 400 will be needed with its input axle 405 connected to the axle 81 of the motor 80, and its output axle 410 is connected to a mechanical load. The speed reducer 400 will reduce the motor rotary speed, but will increase the motor's mechanical force at its output axle 410.

Refer to FIG. 6. The rotor 80R and the stator 80S have equal widths. The top of the stator 80S has an inclined surface 70 sloping rearward and downward. A centered, angled round hole 82 is drilled perpendicular to the inclined surface 70, and inside angled round hole 82 is a stabilizing round plug 86 holding a pointed metallic prong 88. The stator's prong 88 is connected to a charging line 90A. There is a V-shape groove 84 that runs throughout the length and center of the inner surface of the curved stator 80S. The angled round hole 82 intersect the V-shape groove 84 and form a cavity (chamber) within the stator 80S. The rotor 80R has a plurality of equally spaced side holes 83 and with equal sizes. Each side hole 83 intersect a smaller rim hole 87A inside the rotor 80R. The hole 87A is perpendicular to the side hole 83 and centered on the rim of the rotor 80R; it is for a rotor prong 87. Each side hole 83 have sharp metal wires 85A connected to a rotor pointed metallic prong 87. The charging line (position) 200 and discharging line (position) 100 are shown.

When a rotor prong 87 line up with a charging position 200 it will be adjacent and opposite the stator prong 88. The rotor prong 87 and the stator prong 88 are charged simultaneously with like charges near each other in the centered round hole 82; the lower part of this hole 82 acts like an inner chamber for the electrostatic energies. There is a great repulsion force between both pointed metallic prongs 87 and 88. Next, the prong 87 of the rotor 80R moves into its discharging position. There is a continuous rotation 300 of the rotor 80R by a continuous power sequence. A plurality of protruding pointed metallic prongs 87 of the rotor 80R passes through the V-shape groove 84 in the curved stator 80S.

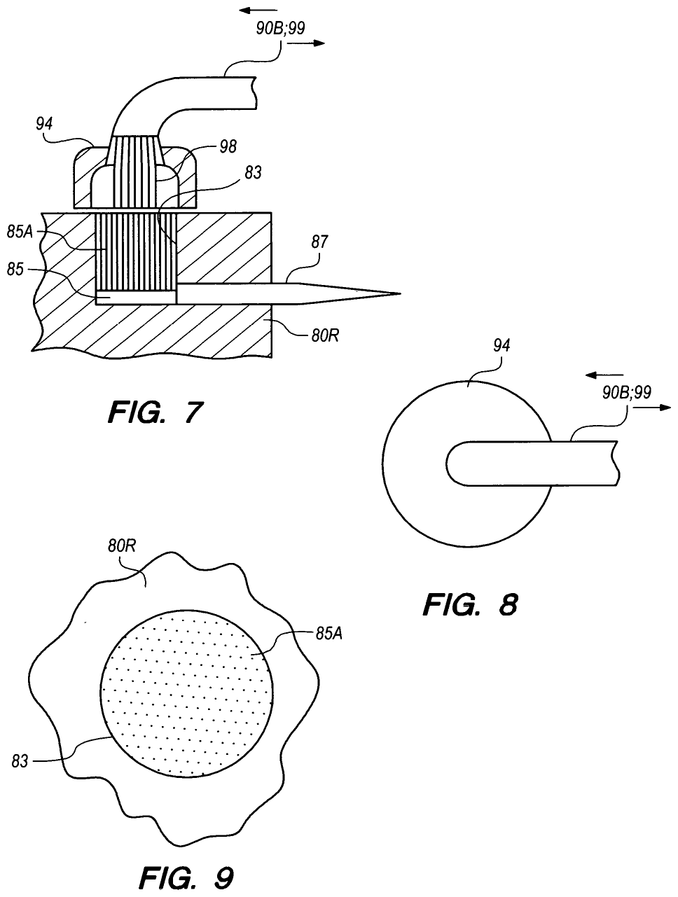

Refer to FIG. 7. This is a detail view of an assembly that can be used to charge a pointed metallic prong 87 in the rotor 80R or discharge the prong 87. The rotor charging line 90B and the rotor discharging line 99 each has an electrical insulation cover cap 94. The cap 94 has sharp metal wires 98 therein, the cap 94 is placed near the rotor 80R. And the cap 94 is in alignment over a side hole 83 near the rim of the rotor 80R.

For charging, the charges travel from the upper sharp metal wires 98 in the cover cap 94 to the lower sharp metal wires 85A and its metallic cylindrical base 85 in the side hole 83, then to the pointed metallic prong 87. For discharging, the charges travel in a reverse path from the prong 87 to the discharging line 99. There is charging and discharging by electrostatic induction as the rotor 80R rotates.

FIG. 8. shows the cover cap 94 with a typical line 90B or 99 used for charging or discharging, respectively. FIG. 9 shows the side hole 83 in the side of the rotor 80R comprising sharp metal wires 85A. Review FIGS. 4, 5, 6 and 7 for a complete understanding of this ELECTROSTATIC REPULSION MOTOR 80.

If there is a need for a greater terminal voltage, higher reliability and a long lifetime; a Pelletron or Laddertron electrostatic generator can replace the Van de Graaff electrostatic generator. The Pelletron and Laddertron electrostatic generators each has a moving charging chain instead of a moving charging belt 36 of FIG. 2. The charging chain is more durable and resist any spark damages, no dust or moisture problem like a charging belt and has a very great terminal voltage. It can produce a stabilized terminal voltage up to and above 25 MV. Very few applications will need voltages at this level.

The Pelletron and Laddertron generators works on the same basic electrostatic principles as the Van de Graaff generator. However, their charging chains are metals and are charged and discharged by the principal of electrostatic induction. The Pelletron was developed first in the 1960s. The Laddertron is more complicated but not more advance than the Pelletron; it was developed much later.

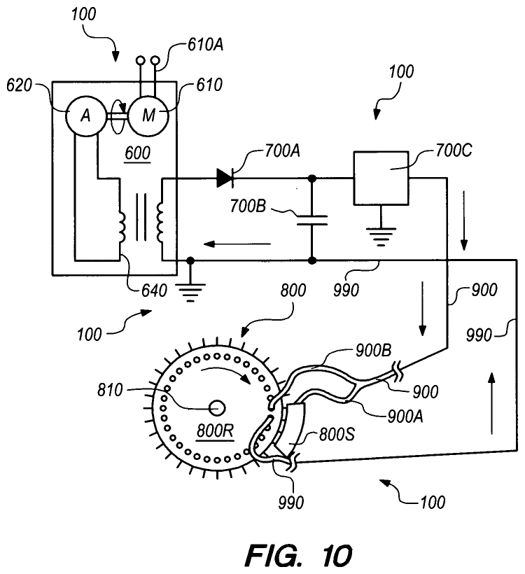

FIG. 10 is an alternative ELECTROSTATIC POWER CIRCUIT 100. A high AC voltage generator 600 comprises an electric motor 610 and its electrical input terminals 610A, an alternator 620 and a step-up transformer 640. The transformer 640 is connected to a diode 700A, filter capacitor 700B, electronic voltage regulator 700C, and input and output lines 900, 990 respectively. An ELECTROSTATIC REPULSION MOTOR 800 has a rotor 800R with its axle 810 and a stator 800S. The main charging line 900 is connected in parallel to the stator charging line 900A and rotor charging line 900B and there is a discharging line 990 to connect the rotor 800R to the filter capacitor 700B and the step-up transformer 640 and close the circuit 100 at ground.

The electric motor 610 can be an electromagnetic motor or an electrostatic one. The diode 700A is a half-wave rectifier it can be replaced with a full-wave rectifier (4 diodes), see FIG. 3. And there can be more than one filter capacitor 700B in the circuit 100.

It has been noted that electromagnetic (EM) motors are quite inefficient in scaled-down versions, very small electrostatic (ES) motors may be a better choice for miniaturized systems. Miniature and small electrostatic motors will find many applications where only small to very small torques and powers are needed.

Powering an electrostatic generator with an electrostatic motor could increase its electrical energy to mechanical energy efficiency. The belt 36 (see FIG. 2) could be made from Kevlar this could increase the efficiency and durability of a Van de Graaff electrostatic generator 30.

The powering of much smaller ELECTRIC POWER PLANTS is possible with more efficiency and a cleaner environment; they can be placed near urban areas; see FIGS. 1-9. Large to very large industrial or commercial facilities can be made more ideal with a Pelletron electrostatic generator. The Electrostatic Power Circuit of FIG. 10 can be made safe, mobile, efficient, economical, compact and non-polluting of the environment. This will be good for AUTOMOTIVE and MARINE applications.

The only thing that has to be design and manufactured is the Electrostatic Repulsion Motor. Solar panels, batteries, electromagnetic motors and generators, transformers, wind generators, speed reducers, diodes, capacitors, thermoelectric generators and many other equipment, devices, meters and parts already exist.

I claim:

1. An electrostatic power system having a control panel of switches and meters, alternative switches and meters, alternative energy sources with storage means and an electrostatic power circuit; said electrostatic power circuit having;
input terminals for a High DC Voltage Generator, said generator comprises an electric motor-alternator combination, output terminals of said alternator are connected to the input terminals of a step-up transformer, said transformer output terminals are connected to the input terminal of a full-wave rectifier, said rectifier has one output terminal constructed to be a source of electric charges having an end with a set of sharp metal wires adjacent a belt of a Van de Graaff Electrostatic Generator;
input terminals of another set are connected to a second electric motor, said motor is connected to a drive pulley of said Van de Graaff Electrostatic Generator, said drive pulley is connected to said belt, said belt is farther connected to a terminal pulley inside a high-voltage terminal comprising a hollow metallic dome of said electrostatic generator, outside of said high-voltage terminal is connected electrically to an Electrostatic Repulsion Motor by its main charging line;
said Electrostatic Repulsion Motor comprises disk shaped rotor and its axle adjacent a curved stator, both have the same width, the curvature of the rim of said rotor matches the curvature of the inner surface of said stator;
said main charging line is connected in electrically parallel to a rotor charging line and a stator charging line and there is a discharging line for said rotor;
said rotor has centered and equally spaced pointed metallic prongs around its rim, and equally spaced side holes near its rim and on one side of said rotor, each metallic prong has a side hole;
said rim is perpendicular to said side hole, and centered on the rim of said rotor and therein is a said metallic prong, each said side hole within has sharp metal wires connected to a said rotor pointed metallic prong;
two assemblies are needed, said charging cover cap and said discharging cover cap are adjacent each other, each said cover cap is in alignment over a side hole near said rim of said rotor, there is electrically connection by electrostatic induction between the two said stationary cover caps and their movable two said side holes in said rotor;
stator top side has an inclined surface sloping rearward and downward, a centered angled round hole is drilled perpendicular to said inclined surface;
said stator pointed metallic prong is connected to said charging line, there is a V-shape groove that runs throughout the length and center of the inner surface of said curved stator, and
said rotor discharging line connected to said discharging cover cap is grounded and thereby completing said Electrostatic Power Circuit between said Electrostatic Repulsion Motor and said High DC Voltage Generator.

2. An electrostatic power system having a control panel of switches and meters, alternative energy sources with storage means and an electrostatic power circuit; said electrostatic power circuit having:
input terminals for a High DC Voltage Generator, said generator comprises an electric motor-alternator combination, output terminals of said alternator are connected to the input terminals of a step-up transformer, said transformer output terminals are connected to the input terminals of a full-wave rectifier, said rectifier has one output terminal constructed to be a source of electric charges having an end with a set of sharp metal wires adjacent a belt of a Van de Graaff Electrostatic Generator;
input terminals of another set are connected to a second electric motor, said motor is connected to a drive pulley of said Van de Graaff Electrostatic Generator, said drive pulley is connected to said belt, said belt is farther connected to a terminal pulley inside a high-voltage terminal comprising a hollow metallic dome of said electrostatic generator; outside of said high-voltage terminal is connected electrically to an Electrostatic Repulsion Motor by its main charging line;
said Electrostatic Repulsion Motor comprises a disked shaped rotor and its axle adjacent a curved stator, both have the same width, the curvature of the rim of said rotor matches the curvature of the inner surface of said stator;
said main charging line is connected in electrically parallel to a rotor charging line and a stator charging line and there is a discharging line for said rotor;
said rotor has centered and equally spaced pointed metallic prongs around its rim, and equally spaced side holes near its rim and on one side of said rotor, each metallic prong has a side hole;
said rim hole is perpendicular to said hole, and centered on the rim of said rotor and there is a said metallic prong within each said rim hole, and each said side hole has sharp metal wires within connected to a said rotor pointed metallic prong;
two assemblies are needed said charging cover cap and said discharging cover cap are adjacent each other, each said cover cap is in alignment over a side hole near said rim of said rotor, there is electrically connection by electrostatic induction between the two said stationary over caps and their two said movable side holes in said rotor;
stator top side has an inclined surface sloping rearward and downward a centered angled round hole is drilled perpendicular to said inclined surface;
said stator pointed metallic prong is connected to said charging line, there is a V-shape groove that runs throughout the length and center of the inner surface of said curved stator;
said rotor discharging line connected to said discharging cover cap is grounded and thereby completing said Electrostatic Power Circuit between said Electrostatic Repulsion Motor and said High DC Voltage Generator, and
a speed reducer input axle is connected to said axle of said electrostatic repulsion motor, the output axle of said speed reducer is connected to a mechanical load.

3. An electrostatic power system having a control panel of switches and meters, alternative energy sources with storage means and an electrostatic power circuit; said electrostatic power circuit having:
input terminals to a High AC Voltage Generator comprising an electric motor-alternator combination, output terminals of said alternator are connected to the input terminals of a Step-up Transformer, one output terminal of said transformer is connected to a Half-Wave Rectifier;
said rectifier comprises a diode connected in parallel to one terminal of a Filter Capacitor and to an Electronic Voltage Regulator, and second terminal of said capacitor is connected to second output terminal of said transformer;
said voltage regulator is connected to an Electrostatic Repulsion Motor by a main charging line, said motor comprises a rotor with an axle and charging and discharging lines;
said main charging line is connected in electrical parallel to said rotor charging line and stator charging line, and
said discharging line of said rotor is connected to said second terminal of said capacitor.
